(19) United States
(12) Patent Application Publication
(10) Pub. No.: US 2023/0309523 A1
(43) Pub. Date: Oct. 5, 2023

(54) FISHING ROD SINKER STORAGE SYSTEM AND METHODS OF USE

(71) Applicant: Mike Smith, Nicholson, GA (US)

(72) Inventor: Mike Smith, Nicholson, GA (US)

(21) Appl. No.: 18/162,283

(22) Filed: Jan. 31, 2023

Related U.S. Application Data
(60) Provisional application No. 63/325,232, filed on Mar. 30, 2022.

(51) Int. Cl. A01K 87/00; A01K 95/00

(52) U.S. Cl. CPC A01K 87/009; A01K 95/00

(57) ABSTRACT

An apparatus to store a fishing sinker on a fishing rod, having a tube with an open top and an open bottom, said tube having a vertical opening formed from said top to said bottom, a bottom cap with an opening formed therein, said opening configured to match said vertical opening, said bottom cap affixed to said open bottom of said tube, an attachment device to mount said tube to the fishing pole, and, thus, functions to provide a way to keep heavy fishing sinkers secured to the pole when not in use, to prevent personal injury, equipment damage, or boat damage.

### CROSS-REFERENCE TO RELATED APPLICATIONS

To the full extent permitted by law, the present United States Non-provisional Patent Application hereby claims priority to and the full benefit of, U.S. Provisional Application No. 63/325,232, filed on Mar. 30, 2022, entitled “Fishing Rod Sinker Control and Storage System”, and U.S. Provisional Application No. 63/326,305, filed on Apr. 1, 2022, entitled “Fishing Rod Sinker Control and Storage System”, which is incorporated by reference herein in its entirety.

### FIELD OF THE DISCLOSURE

The present disclosure is directed to fishing pole accessories. More specifically, the present disclosure is directed to an apparatus to secure a fishing weight or sinker used in conjunction with a fishing line and fishing lure or hook and to secure the sinker to the fishing rod.

### BACKGROUND

Fishing weight storage devices are essential pieces of equipment for any fisherman. Designed to store and organize weights, they can help anglers stay organized, reduce clutter, and free up valuable tackle box space.

Modem day fishing weight systems come in a variety of shapes, sizes, and colors, making them perfect for both recreational and professional fishermen. They are designed to save space when storing multiple weights, and often contain drawers, lids, and dividers. Additionally, some devices feature compartments that are designed to be used with specific types of weights, such as jig heads or drop shot weights.

One disadvantage to these systems is they do not assist with storing the fishing weight or sinker used in conjunction with a fishing line and fishing lure or hook and to secure the sinker to the fishing rod to prevent the fishing weight or sinker from causing damage.

Therefore, it is readily apparent that there is a recognizable unmet need for a fishing rod sinker storage system and methods of use that may be configured to address at least some aspects of the problems discussed above common to transporting fishing rods with sinkers.

### SUMMARY

Briefly described, in an example embodiment, the present disclosure may overcome the above-mentioned disadvantages and may meet the recognized need for a fishing rod sinker storage system and methods of use to provide an apparatus to store a fishing sinker on a fishing rod, the apparatus having a tube with an open top and an open bottom, the tube having a vertical opening or slot formed therein from the top to the bottom of the tube to enable a fishing line to be inserted therein and pass therethrough, a bottom end cap with an opening or slot formed therein, said opening configured to match said vertical opening, said bottom end cap affixed to said open bottom of said tube to catch the fishing sinker or weight therein, and an attachment device to mount the tube to the fishing pole and, thus, functions to efficiently collect and store a fishing sinker or weight to prevent personal injury, equipment damage, vehicle damage, or boat damage caused by a free swinging fishing sinker or weight.

Accordingly, in one aspect, the present disclosure enables the collection, storage and transport of a fishing sinker or weight connected to a fishing line and fishing pole.

Accordingly, in another aspect, the present disclosure may include a top end cap having a top flange with an inside rim, with an opening that matches the main tube to protect the fishing line and fishing sinker or weight while entering the main tube from snagging the line and scratching the sinker or weight.

Accordingly, in another aspect, the present disclosure provides a U channel for stability and spacing and mounting straps to removeably affix the fishing rod sinker storage system to a fishing rod.

In an exemplary embodiment of a fishing rod sinker storage system may include a tube with a first end opening and a second end opening, the tube having a vertical opening formed from the first end opening to the second end opening, wherein the first end opening and the vertical opening enable insertion of the fishing sinker and the fishing line therein, a bottom cap with a cap opening formed therein, the cap opening configured to match the vertical opening, the bottom cap affixed to the second end opening of the tube, wherein the first end opening, the vertical opening, and the cap opening enable insertion and hold of the fishing sinker therein the tube and the fishing line to pass therethrough the tube, and an attachment device to mount the tube to the rod of the fishing pole.

A feature of the present disclosure may include a control device for heavy offshore fishing weights to prevents the weights from becoming a wrecking ball when there are rough sea conditions.

A method of storing a fishing sinker having a fishing line with a hook to a rod with an eyelet of a fishing pole and a reel, the method comprising providing a tube with a first end opening and a second end opening, the tube having a vertical opening formed from the first end opening to the second end opening, a bottom cap with an end plate and a cap opening formed therein, the cap opening configured to match the vertical opening, the bottom cap affixed to the second end opening of the tube, affixing the tube to the rod of the fishing pole, positioning the fishing sinker and the fishing line through the first end opening, the vertical opening, and the cap opening, and lowering the fishing sinker therein the tube on to the end plate of the bottom cap.

A feature of the present disclosure may include its one piece construction with no moving parts.

A feature of the present disclosure includes securing any sinker form that will fit in the cylinder.

A feature of the present disclosure includes securing sinkers no matter what material they are made of.

A feature of the present disclosure includes securing sinkers to take the weight of the sinker off the rod tip and transfers it to the cylinder affixed at the base of the rod . Under normal storage procedures the weight will bounce and shake around when engaging rough water or rough bouncy transport conditions. The rod tip will bend slightly allowing slack in the line, eventually letting the weight to be released or come free. With this disclosure the line tension remains constant.

A feature of the present disclosure is that it is easier to secure the line when you are securing the rod. Normally you are fighting the weight and movement of the weight while trying to secure the hook. With my disclosure the first thing that you do is secure the weight in the cylinder, thus leaving you with nothing but the line weight, and lure or hook to worry about.

A feature of the present disclosure may include easy and convenient access to fishing weight or sinker at the fishing pole.

A feature of the present disclosure may include improved organization and storage of fishing weight or sinker that is currently in use.

A feature of the present disclosure may include protection from accidental damage such as personal injury, equipment damage, vehicle damage, or boat damage caused by a free swinging fishing sinker or weight.

A feature of the present disclosure may include preventing the fishing weight or sinker from being lost in a jumble of tackle.

A feature of the present disclosure may include easier clean-up at the end of a fishing trip, allowing anglers to quickly store their tackle, such as fishing weight or sinker right on the fishing pole.

A feature of the present disclosure may include the Sinker being controlled in the cylinder as long as the rod is in a normal upright position. With the rod in the boat rod holder it its controlled while traveling or baiting hooks. If you turn the rod upside down while the sinker is controlled in the cylinder the sinker will slide out of the cylinder and move up the line toward the tip. The tight or tensioned line keeps the sinker pulled up against the cylinder in a controlled position.

A feature of the present disclosure may include holding the weight while baiting hooks by taking the weight of that swinging sinker off your hand while baiting hooks.

These and other features of the a fishing rod sinker storage system and methods of use will become more apparent to one skilled in the art from the prior Summary and following Brief Description of the Drawings, Detailed Description of exemplary embodiments thereof, and Claims when read in light of the accompanying Drawings or Figures.

### BRIEF DESCRIPTION OF THE DRAWINGS

The present fishing rod sinker storage system and methods of use will be better understood by reading the Detailed Description of the Preferred and Selected Alternate Embodiments with reference to the accompanying drawing Figures, in which like reference numerals denote similar structure and refer to like elements throughout, and in which:

FIG. 1 is a perspective side view of an exemplary embodiment of a fishing rod sinker storage system according to select embodiments of the instant disclosure;

FIG. 2 is a top view of an exemplary embodiment of a fishing rod sinker storage system according to select embodiments of the instant disclosure in FIG. 1;

FIG. 3 is a bottom view of an exemplary embodiment of a fishing rod sinker storage system according to select embodiments of the instant disclosure in FIG. 1;

FIG. 4 is an exploded side view of an exemplary embodiment of a fishing rod sinker storage system according to select embodiments of the instant disclosure;

FIG. 5 is a perspective view of another exemplary embodiment of a fishing rod sinker storage system shown affixed to a fishing pole rod according to select embodiments of the instant disclosure;

FIG. 6.1 is a side view of a cutaway of another exemplary embodiment of a fishing rod sinker storage system with line and sinker above the tube according to select embodiments of the instant disclosure;

FIG. 6.2 is a side view of a cutaway of another exemplary embodiment of a fishing rod sinker storage system with line and sinker trapped in the tube according to select embodiments of the instant disclosure;

FIG. 6.3 is a side view of a fishing pole and of another exemplary embodiment of a fishing rod sinker storage system with line and sinker trapped in the tube and taught line according to select embodiments of the instant disclosure;

FIG. 7 is a perspective side view of an alternate exemplary embodiment of a fishing rod sinker storage system according to select embodiments of the instant disclosure;

FIG. 8 is a perspective side view of an alternate exemplary embodiment of a fishing rod sinker storage system attachment mechanism according to select embodiments of the instant disclosure; and

FIG. 9 is a perspective view of an alternate exemplary embodiment of a fishing rod sinker storage system shown affixed to a fishing pole rod according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

In describing the exemplary embodiments of the present disclosure, as illustrated in the figures specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples. It is recognized herein that the optimum dimensional relationships, to include variations in size, materials, shape, form, position, connection, function and manner of operation, assembly and use, are intended to be encompassed by the present disclosure.

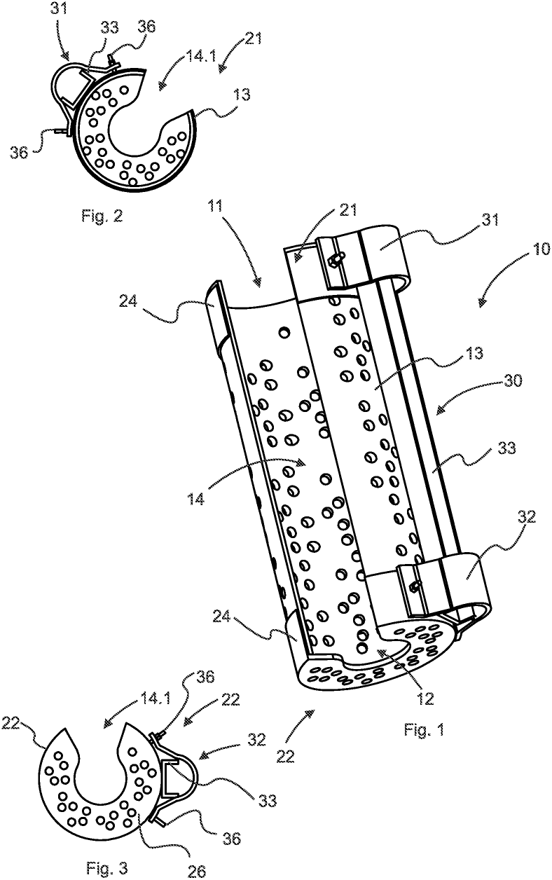

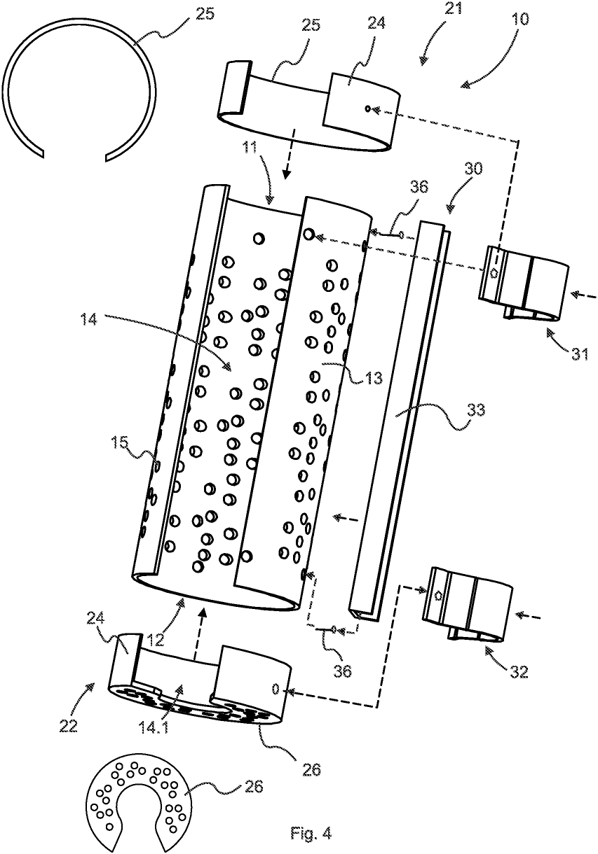

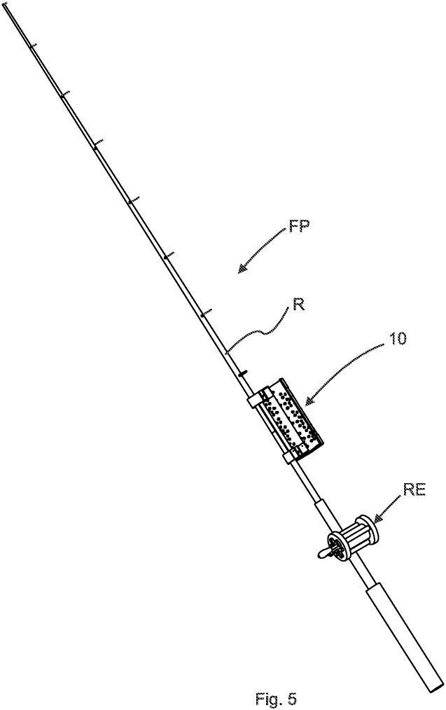

Referring now to FIGS. 1, 2, 3, 4, and 5, by way of example, and not limitation, there is illustrated an example embodiment of an apparatus to store a fishing weight or sinker on a fishing rod, such as fishing rod sinker storage system 10 and its parts, according to select embodiments. In this first embodiment, fishing rod sinker storage system 10 may include a main body preferably cylindrical, such as tube 13 having an open top and bottom. Moreover, tube 13 may include first end opening 11 and second end opening 12, where first end opening 11 enables access, insertion or placement of fishing weight or sinker S therein and removal therefrom tube 13. Furthermore, tube 13 may include an elongated access slot, such as vertical opening 14 running from the top to the bottom, such as from first end opening 11 to second end opening 12 to enable access, insertion or placement of fishing line FL therein, to pass therethrough, and removal therefrom tube 13 so fishing weight or sinker S may be placed in and held therein tube 13 or removed from tube 13.

It is contemplated herein that tube 13 may have a set of holes or apertures, such as perforated surface 15 to reduce overall weight and provide drainage and visual inspection of fishing weight or sinker S and fishing line FL therein tube 13.

It is further contemplated herein that tube 13 may include variations in size, shape, form, and configuration to accommodate different size fishing weight or sinker S.

It is still further contemplated herein that opening may include hole, aperture, or other passageway or entrance therein or therethrough.

Moreover, tube 13 may include an end cap, such as bottom cap 22 to hold or secure fishing weight or sinker S therein tube 13, which provides the resting place for fishing weight or sinker S. Bottom cap 22 may include collar 24 configured to friction fit, affix, or removeably attach to second end opening 12 and end plate 26 configured to stop or hold fishing weight or sinker S therein tube 13. Moreover both collar 24 and end plate 26 may include a slot or cutout formed therein, such as cap opening 14.1 configured to match vertical opening 14 and to enable access, insertion or placement of fishing line FL therein, to pass therethrough, and removal therefrom tube 13 so fishing weight or sinker S may be placed in and held therein tube 13 or removed from tube 13.

It is contemplated herein that bottom cap 22 and vertical opening 14 of tube 13 enable fishing line FL to pass through while holding fishing weight or sinker S therein tube 13.

Furthermore, fishing rod sinker storage system 10 may include an attachment device affixed to tube 13, to mount tube 13 to the base of rod R of fishing pole FP, such as mounting bracket 30. For example, mounting bracket 30 preferably affixed or releasably affixed to tube 13 opposite or adjacent vertical opening 14. Mounting bracket 30 may be configured to enclose or surround fishing pole FP on three sides to provide contact surfaces that may be more stable when mounting bracket 30 may be clamped to the rod of fishing pole FP. It also allows space between the tube and rod R, transitioning from a round surface to a flat one.

Moreover, mounting bracket 30 may include a plurality of mounting straps or clamps, such as first mounting clamp 31 positioned proximate a first end of mounting bracket 30 and second mounting clamp 32 positioned proximate a second end of mounting bracket 30. In use, mounting bracket 30 is positioned proximate the base end of rod R of fishing pole FP to enclose or surround fishing pole FP on three sides and first mounting clamp 31 positioned proximate a first end of mounting bracket 30 and second mounting clamp 32 are affixed or removeably affixed over mounting bracket 30 to secure rod R of fishing pole FP therein mounting bracket 30 and affix or removeably affix tube 13 to rod R of fishing pole FP. Plurality of mounting clamps, such as first mounting clamp 31 and second mounting clamp 32 may utilize pairs of fastener pins mounted to tube 13 proximate mounting bracket 30 and mounting straps, such as first mounting strap 31 and second mounting strap 32 to secure U channel 33 to rod R of fishing pole FP.

It is contemplated herein that other attachment techniques or plurality of fasteners know to one of ordinary skill in the art may be utilized to affix or removeably affix fishing rod sinker storage system 10 to rod R of fishing pole FP.

Still furthermore, tube 13 may include an end cap, such as upper cap 21. Upper cap 21 may include collar 24 configured to friction fit, affix, or removeably attach to first end opening 11. Moreover, upper cap 21 may include an upper cap/rim with an inner lip, such as flange 25 positioned around the rim of upper cap 21 to strengthen first end opening 11 of tube 13 as well as protect fishing line L from sharp edge of first end opening 11 of tube 13. Upper cap 21 may be configured as a vertical opening that matches first tube end opening 11.

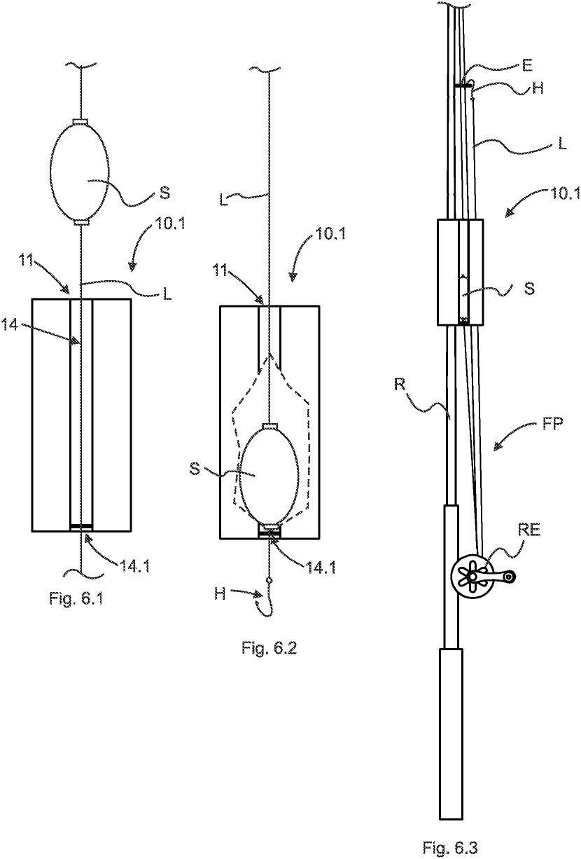

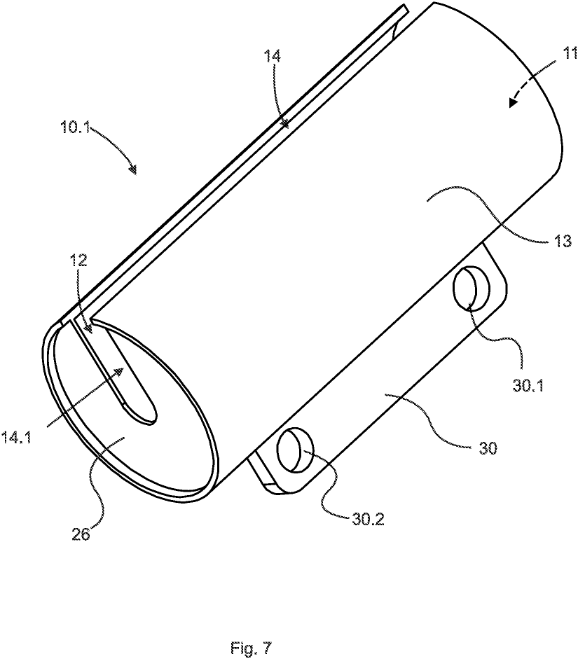

Referring now to FIGS. 6.1, 6.2, and 6.3, by way of example, and not limitation, there is illustrated an example embodiment of an apparatus or method to store a fishing weight or sinker on a fishing rod, such as fishing rod sinker storage system 10 and its parts, according to select embodiments. In use, fishing rod sinker storage system 10 may be affixed (affixing)to rod R of fishing pole FP. An angler may grip fishing line L above fishing weight or sinker S and position fishing line L therethrough vertical opening 14 running from the top to the bottom, such as from first end opening 11 to second end opening 12 ready to lower(lowering) fishing weight or sinker S inside tube 13. Next step, angler may lower fishing line L into tube 13, and more specifically lower(lowering) fishing weight or sinker S through first end opening 11 enables access, insertion or placement of fishing weight or sinker S therein tube 13 where fishing weight or sinker S rests or seats on bottom cap 22 and end plate 26 configured to stop or hold fishing weight or sinker S therein tube 13. Once fishing weight or sinker S is in tube 13 all the weight is off fishing line L. An angler may open the free spool switch on reel RE to allow for the slack fishing line L needed to finish the storing operation.

Next step, an angler may grip a leader of fishing line L extending from fishing weight or sinker S and extending through bottom cap 22 and end plate 26 or hook H positioned on this section of leader fishing line L and wrap fishing line L down around casting mechanism, such as fishing reel R and back up to loop (looping), position, or place hook H into eyelet E of rod R of fishing pole FP positioned above fishing rod sinker storage system 10.

It is recognized herein that fishing sinker S may be attached to a fishing line FL with hook H and with rod R of fishing pole FP having reel RE.

Alternatively, it is contemplated herein that a catch may be affixed to the rod R of fishing pole FP between bottom cap 22 and reel RE or a catch may be affixed to the reel RE to anchor the slack loop of fishing line L.

Next step, an angler may operate (operating) reel RE to tighten fishing line L and pull fishing weight or sinker S tightly up against bottom cap 22 and end plate 26 to control fishing weight or sinker S therein tube 13 and to efficiently collect and store fishing weight or sinker S tightly to prevent personal injury, equipment damage, vehicle damage, or boat damage caused by a free swinging fishing sinker or weight.

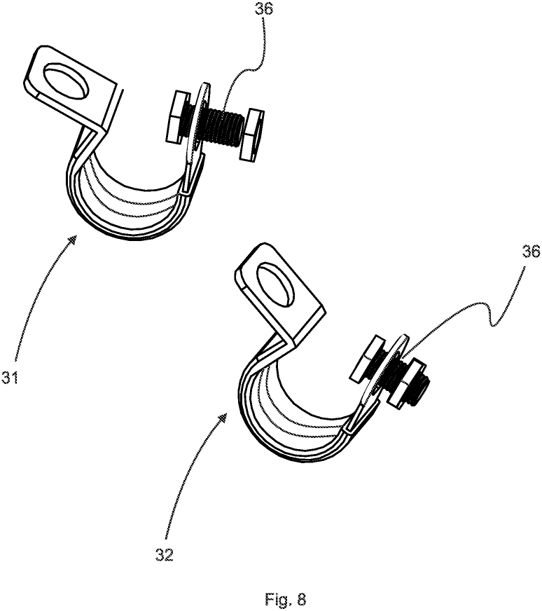

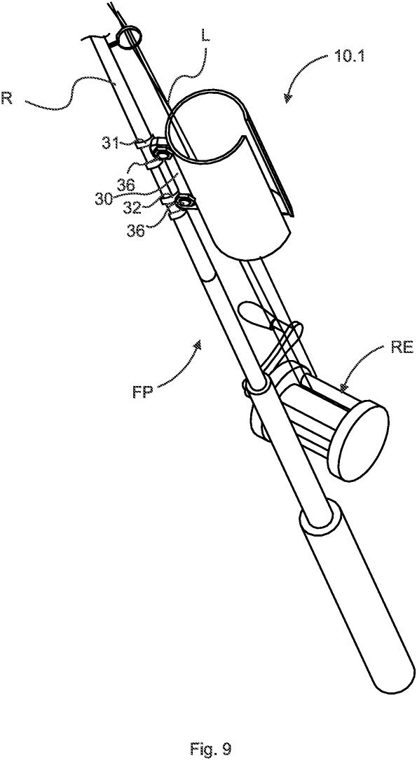

Referring now to FIGS. 7, 8, and 9, by way of example, and not limitation, there is illustrated an example embodiment of an apparatus to store a fishing weight or sinker on a fishing rod, such as alternate fishing rod sinker storage system 10.1 and its parts, according to select embodiments. In this embodiment, fishing rod sinker storage system 10.1 may include a main body preferably cylindrical, such as tube 13 having an open top and bottom (section). Moreover, tube 13 may include first end opening 11 and second end opening 12, where first end opening 11 enables access, insertion or placement of fishing weight or sinker S therein and removal therefrom tube 13. Furthermore, tube 13 may include an elongated access slot, such as vertical opening 14 running from the top to the bottom, such as from first end opening 11 to second end opening 12 to enable access, insertion or placement of fishing line FL therein, to pass therethrough, and removal therefrom tube 13 so fishing weight or sinker S may be placed in and held therein tube 13 or removed from tube 13.

Moreover, second end opening 12 may include end plate 26 configured to stop or hold fishing weight or sinker S therein tube 13 affixed or formed as part of tube 13. Moreover end plate 26 may include a slot or cutout formed therein, such as cap opening 14.1 configured to match vertical opening 14 and to enable access, insertion or placement of fishing line FL therein, to pass therethrough, and removal therefrom tube 13 so fishing weight or sinker S may be placed in and held therein tube 13 or removed from tube 13.

It is contemplated herein that cap opening 14.1 of end plate 26 and vertical opening 14 of tube 13 enable fishing line FL to pass through while holding fishing weight or sinker S therein tube 13.

Furthermore, fishing rod sinker storage system 10.1 may include an attachment device affixed to tube 13, to mount tube 13 to the base of rod R of fishing pole FP, such as mounting bracket 30. For example, mounting bracket 30 may be affixed or formed thereon tube 13. Mounting bracket 30 may include one or more mounting holes, such as first mounting hole 30.1 and second mounting hole 30.2 to preferably affixed or releasably affix mounting bracket 30 to rod of fishing pole FP.

Moreover, mounting bracket 30 may include a plurality of mounting straps or clamps, such as first mounting clamp 31 positioned proximate first mounting hole 30.1 and second mounting clamp 32 positioned proximate second mounting hole 30.2. In use, mounting bracket 30 may be positioned proximate the base end of rod R of fishing pole FP and first mounting clamp 31 positioned proximate first end of mounting bracket 30 and second mounting clamp 32 positioned proximate second end of mounting bracket 30 are affixed or removeably affixed around rod R to secure fishing rod sinker storage system 10.1 to rod R of fishing pole FP. Plurality of mounting clamps, such as first mounting clamp 31 and second mounting clamp 32 may utilize pairs of fastener pins 36 mounted to tube 13 proximate mounting bracket 30 to secure mounting bracket 30 to rod R of fishing pole FP.

It is contemplated herein that mounting bracket 30 and fishing rod sinker storage system 10, 10.1 may be positioned facing up, left, right, underneath or anywhere in between on rod R of fishing pole FP.

It is further contemplated herein that other mounting devices other than mounting bracket 30 and plurality of mounting straps or clamps are contemplated herein.

It is further contemplated herein that other and all possible construction materials are contemplated herein capable of surviving harsh coastal marine environments, such as 316 stainless steel, marine grade aluminum, carbon fiber, suitable plastics and any other applicable materials or like material. These parts will be joined in accordance with the construction material via, TIG welding, spot welding, epoxy, 3D printing and stainless fasteners.

With respect to the description herein, it is to be realized that the optimum dimensional relationships, to include variations in size, materials, shape, form, configuration, position, connection, function and manner of operation, assembly and use, are intended to be encompassed by the present disclosure.

It is contemplated herein that fishing rod sinker storage system 10 components may be constructed of stainless steel, 316 stainless steel, marine grade aluminum, carbon fiber, suitable plastics, or other like materials and of different dimensions. This and other materials herein may be constructed of high density polyethylene or similar high tensile or strengthened materials, as these material offers a variety of forms and shapes and provide strength with reduced weight; however, other suitable materials or the like, can be utilized, provided such material has sufficient strength and/or durability as would meet the purpose described herein to enable fishing rod sinker storage system 10 to meet construction and specifications. It is understood herein that various changes in the material used, shape, size, arrangement of parts, and parts are connected with bolts, pins, screws, glues, adhesives, clamps, wire ties, or similar fasteners or other devices without departing from the spirit of the scope of the claims herein.

It is further understood herein that the parts and elements of this disclosure may be located or position elsewhere based on one of ordinary skill in the art without deviating from the present disclosure.

With respect to the above description then, it is to be realized that the optimum dimensional relationships, to include variations in size, materials, shape, form, position, movement mechanisms, function and manner of operation, assembly and use, are intended to be encompassed by the present disclosure.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail, it should be understood that various changes, substitutions and alterations can be made thereto without departing from the spirit and scope of the disclosure as defined by the appended claims. Accordingly, the present disclosure is not limited to the specific embodiments illustrated herein but is limited only by the following claims.

1. An apparatus to store a fishing sinker attached to a fishing line with a hook with a rod of a fishing pole and a reel, said apparatus comprising:
a tube with a first end opening and a second end opening, said tube having a vertical opening formed from said first end opening to said second end opening, wherein said first end opening and said vertical opening enable insertion of the fishing sinker and the fishing line therein;
a bottom cap with a cap opening formed therein, said cap opening configured to approximately match said vertical opening, said bottom cap affixed to said second end opening of said tube, wherein said first end opening, said vertical opening, and said cap opening enable insertion and hold of the fishing sinker therein said tube and the fishing line to pass therethrough said tube; and
an attachment device to mount said tube to the rod of the fishing pole.

2. The apparatus of claim 1, wherein said tube further comprises an upper cap, said upper cap having an opening configured to match said vertical opening, said upper cap affixed to said open top of said tube.

3. The apparatus of claim 1, wherein said attachment device further comprises a U channel, said U channel affixed to said tube opposite said vertical opening.

4. The apparatus of claim 3, wherein said attachment device further comprises at least one mounting strap, said at least one mounting strap to affix over said U channel to affix said tube to the fishing pole.

5. The apparatus of claim 4, wherein said attachment device further comprises a plurality of fasteners, said plurality of fasteners to affix said U channel to the fishing pole.

6. The apparatus of claim 1, wherein said tube further comprises a perforated surface to reduce overall weight.

7. The apparatus of claim 1, wherein said bottom cap further comprises a collar configured to friction fit to said second end opening of said tube.

8. The apparatus of claim 7, wherein said bottom cap further comprises an end plate configured to stop the fishing sinker therein said tube.

9. The apparatus of claim 1, wherein said bottom cap further comprises a top cap.

10. The apparatus of claim 9, wherein said top cap further comprises a collar configured to friction fit to said first end opening of said tube.

11. The apparatus of claim 10, wherein said collar further comprises a flange positioned around a rim of said top cap to strengthen said first end opening of said tube.

12. The apparatus of claim 11, wherein said flange is configured to protect the fishing line.

13. A method of storing a fishing sinker having a fishing line with a hook to a rod with an eyelet of a fishing pole and a reel, said method comprising:
providing a tube with a first end opening and a second end opening, said tube having a vertical opening formed from said first end opening to said second end opening, a bottom cap with an end plate and a cap opening formed therein, said cap opening configured to approximately match said vertical opening, said bottom cap affixed to said second end opening of said tube;
affixing said tube to the rod of the fishing pole;
positioning the fishing sinker and the fishing line through said first end opening, said vertical opening, and said cap opening; and
lowering the fishing sinker therein said tube on to said end plate of said bottom cap.

14. The method of claim 13, further comprising the step of positioning the hook in the eyelet of the fishing pole.

15. The method of claim 14, further comprising the step of looping the fishing line between the hook and the fishing sinker around the reel of the fishing pole.

16. The method of claim 15, further comprising the step of operating the reel to tighten the fishing line and pull the fishing sinker tightly up against said end plate of said bottom cap to control the fishing sinker therein said tube.
